(19) United States
(12) Patent Application Publication
(10) Pub. No.: US 2025/0182748 A1
(43) Pub. Date: Jun. 5, 2025

(54) VOICE WAKE-UP METHOD, ELECTRONIC DEVICE, AND COMPUTER-READABLE STORAGE MEDIUM

(71) Applicant: AAC ACOUSTIC TECHNOLOGIES (SHENZHEN) CO., LTD., Shenzhen (CN)

(72) Inventors: Zitao Zheng, Shenzhen (CN); Min Jiang, Shenzhen (CN); Hongyan Tao, Shenzhen (CN)

(21) Appl. No.: 18/633,349

(22) Filed: Apr. 11, 2024

Related U.S. Application Data
(63) Continuation of application No. PCT/CN2023/135907, filed on Dec. 1, 2023.

(51) Int. Cl. G10L 15/14; G10L 15/02; G10L 15/22; G10L 15/30; G10L 19/038; G10L 25/21; G10L 25/24

(52) U.S. Cl. CPC G10L 15/144; G10L 15/02; G10L 15/22; G10L 15/30; G10L 19/038; G10L 25/21; G10L 25/24; G10L 2015/223

(57) ABSTRACT

A voice wake-up method, an electronic device, and a computer-readable storage medium are provided. The voice wake-up method comprises collecting an original voice signal input by a user; generating pulse density modulation data according to the original voice signal; decoding the pulse density modulation data to generate decoded data; performing preprocessing and feature extraction processing on the decoded data to generate voice features; performing pattern matching on the voice features according to a hidden Markov model to generate a recognition result; and waking up an external processor of the electronic device according to the recognition result. In the voice wake-up method, a voice wake-up function of the electronic device is realized, which reduce the power consumption of the electronic devices while improving the accuracy of voice wake-up.

### TECHNICAL FIELD

The present disclosure relates to a field of acoustic technology, and in particularly to a voice wake-up method, an electronic device, and a computer-readable storage medium.

### BACKGROUND

A voice wake-up method in the related art generally uses a Micro-Electro-Mechanical System (MEMS) microphone to collect voice signals, then the voice signals are transmitted to a main control chip of an external central processing unit (CPU) through an audio transmission interface thereof, and the main control chip implements a voice wake-up function of the MEMS microphone by running an algorithm. The MEMS microphone requires the external CPU to process and recognize the voice signals, so the external CPU needs to be kept running for a long time and consumes high power. Moreover, the MEMS microphone has a single function, which is not conducive to modularization.

In a signal preprocessing process of the voice wake-up method, an endpoint detection algorithm is commonly adopted to correctly find a starting point and an ending point of a voice signal containing noise. The endpoint detection algorithm is a dual-threshold detection algorithm that combines short-term energy and short-term zero-crossing points to distinguish a silent segment, a transition segment, a voice segment, and an end segment of the voice signal. However, the double-threshold detection algorithm has large errors and computational overhead.

### SUMMARY

In view of defects in the related art, embodiments of the present disclosure provide a voice wake-up method, an electronic device, and a computer-readable storage medium, which reduce power consumption of the electronic devices while improving an accuracy of voice wake-up.

In a first aspect, one embodiment of the present disclosure provides the voice wake-up method applied to the electronic device. The voice wake-up method includes steps:
collecting an original voice signal input by a user;
generating pulse density modulation data according to the original voice signal;
decoding the pulse density modulation data to generate decoded data;
performing preprocessing and feature extraction processing on the decoded data to generate voice features;
performing pattern matching on the voice features according to a hidden Markov model to generate a recognition result; and
waking up an external processor of the electronic device according to the recognition result.

In one optional embodiment, the step of performing preprocessing and feature extraction processing on the decoded data to generate the voice features includes steps:
pre-processing the decoded data by an improved endpoint detection algorithm to generate an effective sound segment of the original voice signal;
extracting feature information of the effective sound segment by a feature extraction algorithm; and
performing vector quantization on the feature information to generate the voice features.

In one optional embodiment, the step of pre-processing the decoded data by the improved endpoint detection algorithm to generate the effective sound segment of the original voice signal includes steps:
filtering an interference signal in the decoded data to generate filtered data;
performing pre-emphasis processing on the filtered data to generate pre-emphasis data;
framing the pre-emphasis data to generate frames of data;
windowing each of the frames of the data to generate windowing data;
extracting effective contents in the windowing data based on the improved endpoint detection algorithm; and
calculating the effective contents based on a Mel-frequency cepstrum coefficient feature extraction algorithm to generate the effective sound segment of the original voice signal.

In one optional embodiment, the improved endpoint detection algorithm includes a formula

$$δ = φ \times \frac{{δ}_{max} - {δ}_{min}}{{ρ}_{max} - {ρ}_{min}} \times ρ .$$

ρ is a short-term energy change rate. δ is a short-term energy threshold. φ is an adjustable influence factor.

In one optional embodiment, the step of performing pattern matching on the voice features according to the hidden Markov model to generate the recognition result includes:

according to the hidden Markov model, performing pattern matching on the voice features by a forward algorithm; determining whether the original voice signal input by the user includes a predetermined command through a predetermined discrimination rule to generate the recognition result.

In one optional embodiment, the step of according to the hidden Markov model, performing pattern matching on the voice features by the forward algorithm and determining whether the original voice signal input by the user includes the predetermined command through the predetermined discrimination rule to generate the recognition result includes:
converting the voice features into symbol sequences by vector quantization, where the voice features are two-dimensional voice features and the symbol sequences are one-dimensional symbol sequences;
exhaustive all state sequences corresponding to a symbol sequence of a current frame of the data to generate feature frame sequences;
obtaining a generation probability of the feature frame sequences generated by each of the state sequences according to a transition probability and a transmission probability;
extending a quantity of states in each of the state sequences to a quantity of feature frames, summing probabilities of generating the feature frame sequences of the state sequences, and using a sum thereof as a likelihood probability that the feature frame sequences are identified as word sequences;
calculating probabilities of the word sequences of the feature frame sequences in the hidden Markov model as prior probabilities of the word sequences;
multiplying the likelihood probability and each of the prior probabilities to obtain posterior probabilities of the word sequences; and
using one of the word sequences having a maximum posterior probability as the recognition result.

In a second aspect, the present disclosure provided the electronic device. The electronic device includes an external processor and a smart microphone.

The smart microphone includes a microphone and a digital signal processor. The microphone is configured to collect an original voice signal input by a user.

The digital signal processor is configured to generate pulse density modulation data according to the original voice signal, decode the pulse density modulation data to generate decoded data; perform preprocessing and feature extraction processing on the decoded data to generate voice features, perform pattern matching on the voice features according to a hidden Markov model to generate a recognition result, and send the recognition result to the external processor.

The external processor is woke up according to the recognition result.

In one optional embodiment, the digital signal processor is further configured to receive the hidden Markov model sent by a server, and the hidden Markov model is trained by the server.

In one optional embodiment, the external processor includes a central processing unit (CPU) or a system-on-chip.

In a third aspect, the present disclosure provides the computer-readable storage medium. The computer-readable storage medium includes a program stored therein. When the program is operated, a device where the computer-readable storage medium is disposed is controlled to execute the voice wake-up method.

In the voice wake-up method of the present disclosure, the original voice signal input by the user is collected, the pulse density modulation data is generated according to the original voice signal, the pulse density modulation data is decoded to generate the decoded data, preprocessing and feature extraction processing are performed on the decoded data to generate the voice features, pattern matching is performed on the voice features according to the hidden Markov model to generate the recognition result, and the external processor of the electronic device is woke up according to the recognition result. In the embodiments of the present disclosure, by performing preprocessing and feature extraction processing on the decoded data to generate the voice features, by performing pattern matching on the voice features according to the hidden Markov model to generate the recognition result, and by waking up the external processor of the electronic device according to the recognition result, a voice wake-up function of the electronic device is realized, which reduce the power consumption of the electronic devices while improving the accuracy of voice wake-up.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of an electronic device according to one embodiment of the present disclosure.

FIG. 2 is a schematic diagram of a circuit structure of the electronic device according to one embodiment of the present disclosure.

FIG. 3 is a flow chart of a voice wake-up method according to one embodiment of the present disclosure.

FIG. 4 is a flow chart of a step 108 of the voice wake-up method according to one embodiment of the present disclosure.

FIG. 5 is a flow chart showing a server training a hidden Markov model according to one embodiment of the present disclosure.

FIG. 6 is a flow chart of a step 110 of the voice wake-up method according to one embodiment of the present disclosure.

### DETAILED DESCRIPTION

In order to better understand technical solutions of the present disclosure, embodiments of the present disclosure are described in detail below with reference to accompanying drawings.

It should be noted that the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

The terminology used in the present disclosure is for a purpose of describing particular embodiments only and does not limit the present disclosure. As used in the present disclosure, singular forms such as “a kind of,” “said”, and “the” are intended to include the plural forms as well, unless the context clearly dictates otherwise.

It should be understood that the term “and/or” depict relationship between associated objects and there are three relationships thereon. For example, A and/or B may indicate A exists alone, A and B exist at the same time, and B exists alone. The character “/” generally indicates that the associated object is alternative.

A MEMS microphone is a microphone manufactured based on MEMS technology. To sum up, the MEMS microphone is a capacitor integrated on a micro silicon wafer. The MEMS microphones is manufactured by a surface mount process, is capable of withstanding high reflow temperatures, and is easily integrated with a complementary metal oxide semiconductor (CMOS) circuit and other audio circuits, Further, the MEMS microphone has an improved noise cancellation performance, a good radio frequency (RF)) performance, and an electromagnetic interference (EMI) suppression performance. The MEMS microphone is commonly used as a voice signal collection unit in products having a voice wake-up function.

One embodiment of the present disclosure provides an electronic device. The electronic device may be true wireless stereo (TWS) headphones, a smart watch, a smart light, a smart robot, etc.

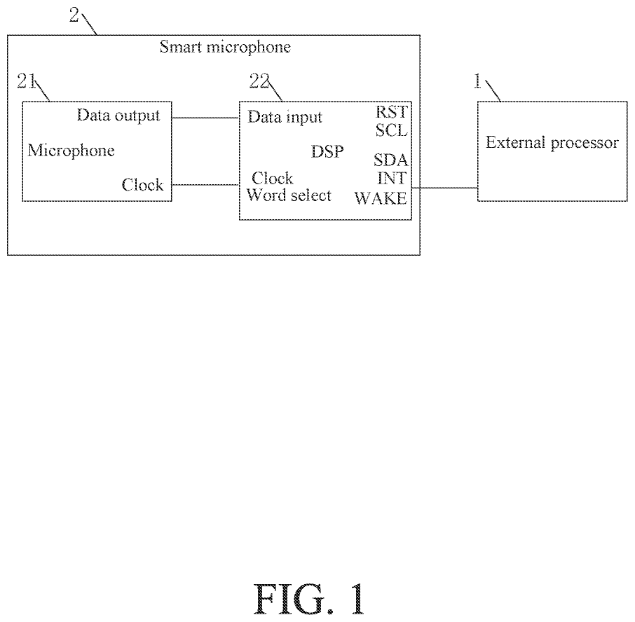

FIG. 1 is a schematic diagram of the electronic device according to one embodiment of the present disclosure. As shown in FIG. 1, the electronic device includes an external processor 1 and a smart microphone 2.

The smart microphone 2 includes a microphone 21 (also named as MIC) and a digital signal processor (DSP) 22. The microphone 21 is connected to the digital signal processor 22, and the external processor 1 is connected to the smart microphone 2. Specifically, the digital signal processor 22 is connected to the external processor 1.

The microphone 21 is configured to collect an original voice signal input by a user.

The digital signal processor 22 is configured to generate pulse density modulation data according to the original voice signal, decode the pulse density modulation data to generate decoded data; perform preprocessing and feature extraction processing on the decoded data to generate voice features, perform pattern matching on the voice features according to a hidden Markov model (HMM) to generate a recognition result, and send the recognition result to the external processor 1.

The external processor 1 is woke up according to the recognition result.

In one embodiment of the present disclosure, the external processor 1 includes a central processing unit (CPU) or a system-on-chip (SOC).

In one embodiment of the present disclosure, the microphone 21 includes a data output interface and a clock interface. The digital signal processor 22 includes a data input interface, a clock interface, a word select interface, and a reset (RST) interface, a serial clock (SCL) interface, a serial data (SDA) interface, an INT interface, and a wake-up (WAKE) interface. The data output interface of the microphone 21 is connected to the data input interface of the digital signal processor 22, and the clock interface of the microphone 21 is connected to the word select interface of the digital signal processor 22.

In one embodiment of the present disclosure, the digital signal processor 22 is specifically configured to pre-process the decoded data by an improved endpoint detection algorithm to generate an effective sound segment of the original voice signal, extract feature information of the effective sound segment by a feature extraction algorithm; and perform vector quantization on the feature information to generate the voice features.

In one embodiment of the present disclosure, the digital signal processor 22 is specifically configured to filter an interference signal in the decoded data to generate filtered data, perform pre-emphasis processing on the filtered data to generate pre-emphasis data, frame the pre-emphasis data to generate frames of data, window each of the frames of the data to generate windowing data, extract effective contents in the windowing data based on the improved endpoint detection algorithm, and calculate the effective contents based on a Mel-frequency cepstrum coefficient feature extraction algorithm to generate the effective sound segment of the original voice signal.

In one embodiment of the present disclosure, the improved endpoint detection algorithm includes a formula

$$δ = φ \times \frac{{δ}_{max} - {δ}_{min}}{{ρ}_{max} - {ρ}_{min}} \times ρ .$$

ρ is a short-term energy change rate. δ is a short-term energy threshold. φ is an adjustable influence factor.

In one embodiment of the present disclosure, the digital signal processor 22 is specifically configured to perform pattern matching on the voice features by a forward algorithm according to the hidden Markov model and determine whether the original voice signal input by the user includes a predetermined command through a predetermined discrimination rule to generate the recognition result.

In one embodiment of the present disclosure, the digital signal processor 22 is specifically configured to convert the voice features into symbol sequences by vector quantization, exhaustive all state sequences corresponding to a symbol sequence of a current frame of the data to generate feature frame sequences, obtain a generation probability of the feature frame sequences generated by each of the state sequences according to a transition probability and a transmission probability; extend a quantity of states in each of the state sequences to a quantity of feature frames, sum probabilities of generating the feature frame sequences of the state sequences, use a sum thereof as a likelihood probability that the feature frame sequences are identified as word sequences, calculating probabilities of the word sequences of the feature frame sequences in the hidden Markov model as prior probabilities of the word sequences, multiply the likelihood probability and each of the prior probabilities to obtain posterior probabilities of the word sequences, and use one of the word sequences having a maximum posterior probability as the recognition result. The voice features are two-dimensional voice features and the symbol sequences are one-dimensional symbol sequences.

In one embodiment of the present disclosure, the digital signal processor 22 receives the hidden Markov model sent by the server, and the hidden Markov model is trained by the server.

In one embodiment of the present disclosure, components and interface connection of the electronic device with the external processor 1 are shown in FIG. 1. The microphone 21 samples and modulates the voice signal that is collected, and then outputs a 0-1 digital string (binary digital string) to the digital signal processor 22 through a pulse density modulation (PDM) interface for processing, recognition, and wake-up. Finally, it is determined whether to wake up the external processor 1 based on the recognition result. In addition, the external processor 1 is allowed to control the digital signal processor 22 through an I2C interface.

In one embodiment of the present disclosure, a size of electronic device is relatively small, which may be 3.5 mm*2.65 mm. The electronic device has high signal-to-noise ratio, high sensitivity, and low power consumption. The electronic device supports keyword recognition, voiceprint recognition, offline recording, voice recognition, customized wake words, and customized command words. A power supply voltage of the electronic device is 3.3V, and a signal-to-interference plus noise ratio (SNR) is 65 dB.

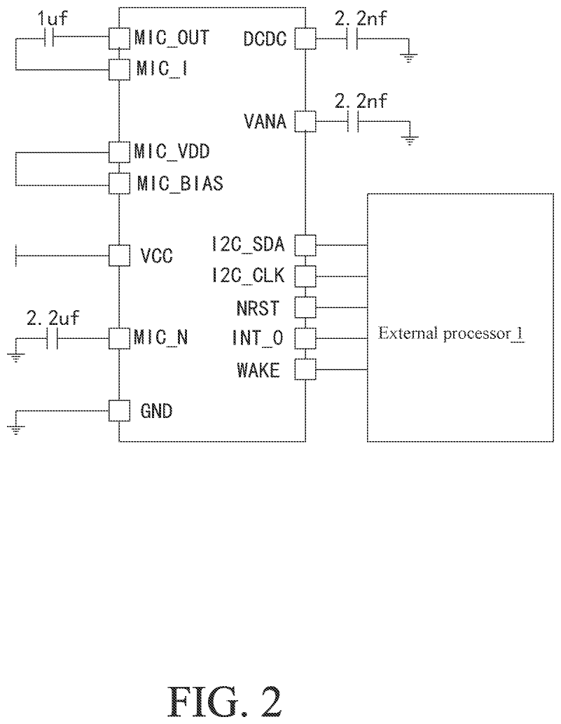

FIG. 2 is a schematic diagram of a circuit structure of the electronic device according to one embodiment of the present disclosure. As shown in FIG. 2, the circuit structure of the electronic device includes an MIC_OUT interface, an MIC_I interface, an MIC_VDD interface, an MIC_BIAS interface, a VCC interface, an MIC_N interface, a GND interface, a DCDC interface, a VANA interface, an I2C_SDA interface, an I2C_CLK interface, an NRST interface, an INT_0 interface and a WAKE interface.

The MIC_OUT interface is connected to the MIC_I interface. The MIC_I interface is connected to the MIC_VDD interface. The MIC_VDD interface is connected to the MIC_BIAS interface. The MIC_BIAS interface is connected to the VCC interface. The VCC interface is connected to the MIC_N interface. The MIC_N interface is connected to the GND interface. The GND interface is connected to the WAKE interface. The WAKE interface is connected to the INT_0 interface. The INT_0 interface is connected to the NRST interface. The NRST interface is connected to the I2C_CLK interface. The I2C_CLK interface is connected to the I2C_SDA interface. The I2C_SDA interface is connected to the VANA interface. The VANA interface is connected to the DCDC interface. The DCDC interface is connected to the MIC_OUT interface.

The MIC_OUT interface and the MIC_I interface are connected through a first capacitor, and a capacitance of the first capacitor may be 1 uf. The MIC_VDD interface is connected to the MIC_BIAS interface. The VCC interface is connected to an external power supply. The MIC_N interface is grounded through a second capacitor, and a capacitance of the second capacitor may be 2.2 uf. The GND interface is grounded. The I2C_SDA interface, the I2C_CLK interface, the NRST interface, the INT_0 interface, and the WAKE interface are connected to the external processor. The VANA interface is grounded through a third capacitor, and a capacitance of the third capacitor may be 2.2 nf. The DCDC interface is grounded through a fourth capacitor, and the capacitance of the fourth capacitor may be 2.2 nf.

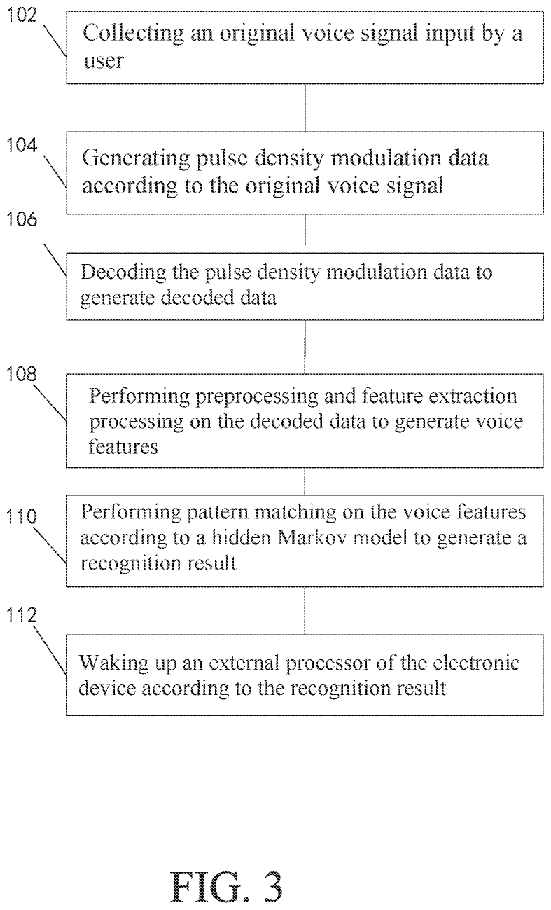

Based on the electronic device shown in FIG. 1, and the circuit structure of the electronic device shown in FIG. 2, the present disclosure further provides a voice wake-up method applied to the electronic device. FIG. 3 is a flow chart of the voice wake-up method according to one embodiment of the present disclosure.

As shown in FIG. 3, the voice wake-up method includes steps 102, 104, 106, 108, 110, and 112.

The step 102 includes collecting an original voice signal input by a user.

In one embodiment of the present disclosure, the steps are executed by the electronic device.

In the step 102, the user inputs the original voice signal to the electronic device by speaking to the electronic device (saying the command word). At this time, the electronic device collects the original voice signal input by the user.

The step 104 includes generating pulse density modulation data according to the original voice signal.

In the step, the original voice signal is converted into PDM data in a PDM format.

The step 106 includes decoding the pulse density modulation data to generate decoded data.

The step 108 includes performing preprocessing and feature extraction processing on the decoded data to generate voice features.

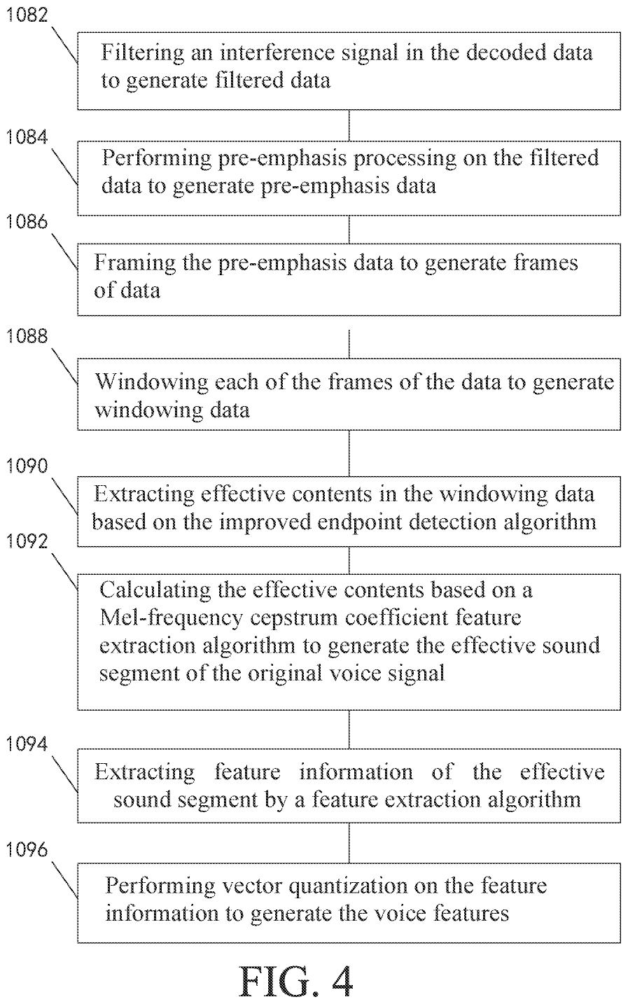

FIG. 4 is a flow chart of the step 108 of the voice wake-up method according to one embodiment of the present disclosure. As shown in FIG. 4, the step 108 includes steps 1082, 1084, 1086, 1088, 1090, 1092, 1094, and 1096.

The step 1082 includes filtering an interference signal in the decoded data to generate filtered data.

In one embodiment of the present disclosure, a deep learning based neural network library and a digital signal processing (DSP) library for hardware floating point operations are adopted.

The step 1084 includes performing pre-emphasis processing on the filtered data to generate pre-emphasis data.

In the step 1084, in order to emphasize a high-frequency part of the original voice signal, the filtered data is pre-emphasized.

The step 1086 includes framing the pre-emphasis data to generate frames of data;

In the step 1086, on order to satisfy Fourier transform's requirements for stability of an input signal, combined with a fact that the original voice signal is a quasi-steady state process in a short time range, the pre-emphasis data is divided into frames, and each of the frames data overlaps an adjacent frame of the data.

The step 1088 includes windowing each of the frames of the data to generate windowing data.

In the step 1088, in order to emphasize a voice waveform of sample n attachments and eliminate an overlap portion between each two adjacent frames of the data, a Hamming window is used to window each frames of the data.

The step 1090 includes extracting effective contents in the windowing data based on the improved endpoint detection algorithm.

In the step 1090, in order to distinguish voice section and non-voice sections, the improved endpoint detection algorithm based on threshold is adopted to extract effective contents.

Specifically, the improved endpoint detection algorithm includes a formula

$$δ = φ \times \frac{{δ}_{max} - {δ}_{min}}{{ρ}_{max} - {ρ}_{min}} \times ρ .$$

ρ is a short-term energy change rate. δ is a short-term energy threshold. φ is an adjustable influence factor.

The improved endpoint detection algorithm introduces a time domain parameter that reflects a degree of change of the signal, that is, the short-term energy change rate. Based on a predetermined initial value of an energy threshold, when an energy change rate of each two adjacent frames of data is small, the energy thresholds of each two adjacent frames of data is also set to have a small difference, which reduces a probability of effective signals being erroneously screened out. In essence, a process of setting a new short-term energy threshold for the signal each time for multiple signal screenings is transformed into a process of performing a primary screening processing by setting different short-term energy thresholds for each of the frames of data. Finally, a secondary screening is performed based on short-term zero-crossing points, which optimizes the computational overhead of the improved endpoint detection algorithm.

The step 1092 includes calculating the effective contents based on a Mel-frequency cepstrum coefficient (MFCC) feature extraction algorithm to generate the effective sound segment of the original voice signal.

In the step 1092, the MFCC feature extraction algorithm uses fast Fourier transformation to extract spectra corresponding to the effective contents, and uses a Mel filter bank to reduce a data amount, imitates a high resolution characteristics of the human ear at low frequencies, and finally uses the static features of the cepstrum coefficients and corresponding difference spectra to improve recognition performance.

The step 1094 includes extracting feature information of the effective sound segment by a feature extraction algorithm.

The step 1096 includes performing vector quantization on the feature information to generate the voice features.

Specifically, vector quantization is performed on the feature information to generate a codebook, and target code vectors (i.e., the voices features) are obtained according to global search.

The step 110 includes performing pattern matching on the voice features according to a hidden Markov model (HMM) to generate a recognition result.

In one embodiment of the present disclosure, the electronic device obtains the hidden Markov model from the server, and the hidden Markov model is trained by the server. Each pattern is trained on the server to generate a corresponding HMM-based voice model, and then a template library is generated and is transplanted to the DSP.

In one embodiment of the present disclosure, an HMM model framework is established, and model parameters of the HMM-based voice models are input into corresponding positions in the HMM model framework. When creating a subsequent embedded project, an HMM machine learning sequence model that has transplanted model parameters of the HMM-based voice models. The model parameters include a state transition matrix, a symbol output probability array, and a rejection recognition probability threshold, etc.

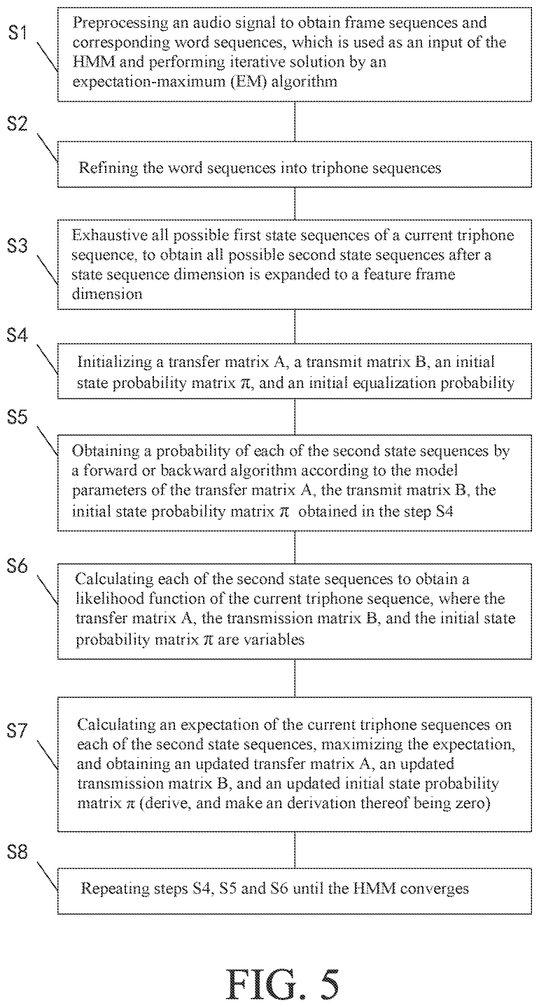

The HMM is a stochastic model method that mainly analyzes the short-term characteristics of voice and a transition relationship between the short-term characteristics, and finally calculates a likelihood probability to make a decision. FIG. 5 is a flow chart showing the server training the hidden Markov model according to one embodiment of the present disclosure. As shown in FIG. 5, A process of the server training the HMM includes steps S1-S8.

The step S1 includes preprocessing an audio signal to obtain frame sequences and corresponding word sequences, which is used as an input of the HMM and performing iterative solution by an expectation-maximum (EM) algorithm.

The step S2 includes refining the word sequences into triphone sequences.

The step S3 includes exhaustive all possible first state sequences of a current triphone sequence, to obtain all possible second state sequences after a state sequence dimension is expanded to a feature frame dimension.

The step S4 includes initializing a transfer matrix A, a transmit matrix B, an initial state probability matrix π, and an initial equalization probability.

The step S5 includes obtaining a probability of each of the second state sequences by a forward or backward algorithm according to the model parameters of the transfer matrix A, the transmit matrix B, the initial state probability matrix π obtained in the step S4.

The step S6 includes calculating each of the second state sequences to obtain a likelihood function of the current triphone sequence, where the transfer matrix A, the transmission matrix B, and the initial state probability matrix π are variables.

The step S7 includes calculating an expectation of the current triphone sequences on each of the second state sequences, maximizing the expectation, and obtaining an updated transfer matrix A, an updated transmission matrix B, and an updated initial state probability matrix π (derive, and make an derivation thereof being zero).

The step S8 includes repeating steps S4, S5 and S6 until the HMM converges.

Specifically, according to the HMM, pattern matching is performed on the voice features by the forward algorithm, and whether the original voice signal input by the user includes a predetermined command is determined through a predetermined discrimination rule to generate the recognition result.

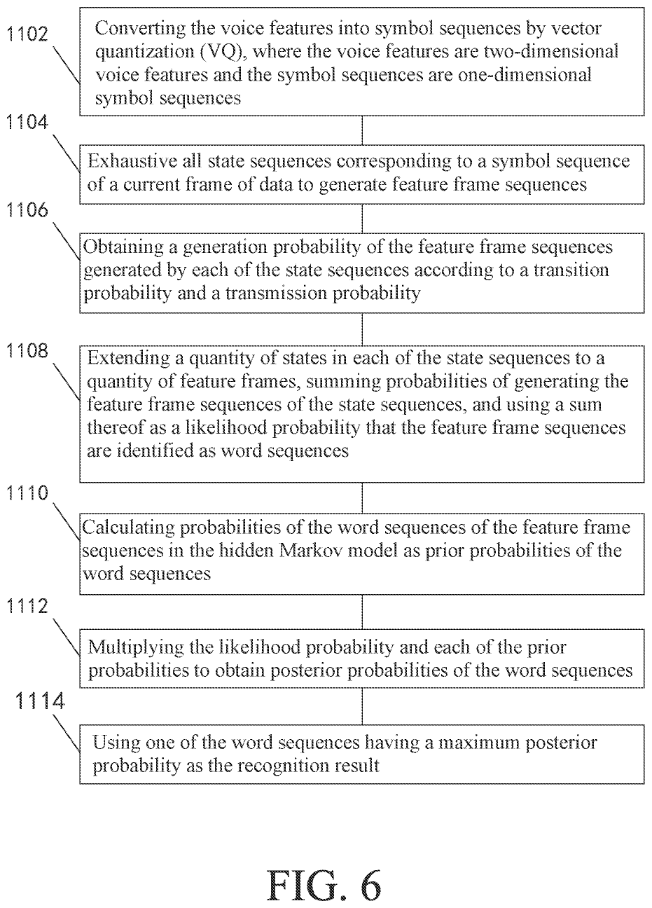

FIG. 6 is a flow chart of a step 110 of the voice wake-up method according to one embodiment of the present disclosure. As shown in FIG. 6, the step 110 includes steps 1102, 1104, 1106, 1108, 1110, 1112, and 1114.

The step 1102 includes converting the voice features into symbol sequences by vector quantization (VQ), where the voice features are two-dimensional voice features and the symbol sequences are one-dimensional symbol sequences.

The step 1104 includes exhaustive all state sequences corresponding to a symbol sequence of a current frame of the data to generate feature frame sequences.

The step 1106 includes obtaining a generation probability of the feature frame sequences generated by each of the state sequences according to a transition probability and a transmission probability.

The step 1108 includes extending a quantity of states in each of the state sequences to a quantity of feature frames, summing probabilities of generating the feature frame sequences of the state sequences, and using a sum thereof as a likelihood probability that the feature frame sequences are identified as word sequences.

The step 1110 includes calculating probabilities of the word sequences of the feature frame sequences in the hidden Markov model as prior probabilities of the word sequences.

A feature frame sequence is far more than the quantity of states corresponding to words. After one word sequence is refined into the state sequences, the quantity of states in the state sequences needs to be expanded to the quantity of the feature frames. The state sequences have many possibilities, and the sum of the probabilities of the state sequences serves as the likelihood that the feature frame sequences is recognized as the word sequence.

The step 1112 includes multiplying the likelihood probability and each of the prior probabilities to obtain posterior probabilities of the word sequences.

The step 1114 includes using one of the word sequences having a maximum posterior probability as the recognition result.

$$Y *= {argmax}_{Y} P ( Y / X ) = {argmax}_{Y} \frac{P ( X / Y ) P ( Y )}{P ( X )} = {argmax}_{Y} P ( X / Y ) P ( Y ) = {argmax}_{Y} P ( X / S ) P ( Y ) = {argmax}_{Y} {\sum }_{h ∈ s} P ( X / h ) P ( Y )$$

P (X) is a prior probability of one of the word sequences, which is obtained from the HMM-base voice models. P (X|Y) is the likelihood probability, which comes from an acoustic model (GMM+HMM), in argmax_{Y} Σ_{h∈s}P(X/h)P(Y), S represents all state sequence combinations of obtained observation sequences Y, and h represents a state sequence in S.

The step 112 includes waking up the external processor of the electronic device according to the recognition result.

In one embodiment of the present disclosure, the command words input by the user are recognized for mating. When the command words are matched, a wake-up signal is output to the external processor, and the external processor is allowed to self-wake up in response to the wake-up signal.

In the voice wake-up method of the present disclosure, the original voice signal input by the user is collected, the pulse density modulation data is generated according to the original voice signal, the pulse density modulation data is decoded to generate the decoded data, preprocessing and feature extraction processing are performed on the decoded data to generate the voice features, pattern matching is performed on the voice features according to the hidden Markov model to generate the recognition result, and the external processor of the electronic device is woke up according to the recognition result. In the embodiments of the present disclosure, by performing preprocessing and feature extraction processing on the decoded data to generate the voice features, by performing pattern matching on the voice features according to the hidden Markov model to generate the recognition result, and by waking up the external processor of the electronic device according to the recognition result, a voice wake-up function of the electronic device is realized, which reduce the power consumption of the electronic devices while improving the accuracy of voice wake-up.

In the technical solutions provided by the embodiments of the present disclosure, the smart microphone is able to store 1-20 seconds of pulse code modulation (PCM) data, perform algorithm processing through the DSP having high performance, and then trigger and wake up the external processor through the WAKE interface to realize the voice wake-up function, which greatly reduces standby power consumption of the external processor.

In the technical solutions provided by the embodiments of the present disclosure, the smart microphone includes the MIC and the DSP having high performance, which realize voice collection, voice processing, voice recognition, and voice wake-up. Compared with a conventional MEMS microphone, the smart microphone provides a complete solution of higher computing resources, which is convenient for the user to carry out secondary development.

In one embodiment, the present disclosure provides a computer-readable storage medium. The computer-readable storage medium includes a program stored therein. When the program is operated, a device where the computer-readable storage medium is disposed is controlled to execute the voice wake-up method. Specific contents are described in the above embodiments.

Foregoing descriptions are only optional embodiments of the present disclosure and are not intended to limit the present disclosure. Any modification, equivalent replacement, or improvement within the technical scope of the present disclosure should be included in the protection scope of the present disclosure.

What is claimed is:

1. A voice wake-up method, applied to an electronic device, comprising steps:
collecting an original voice signal input by a user;
generating pulse density modulation data according to the original voice signal;
decoding the pulse density modulation data to generate decoded data;
performing preprocessing and feature extraction processing on the decoded data to generate voice features;
performing pattern matching on the voice features according to a hidden Markov model to generate a recognition result; and
waking up an external processor of the electronic device according to the recognition result.

2. The voice wake-up method according to claim 1, wherein the step of performing preprocessing and feature extraction processing on the decoded data to generate the voice features comprises steps:
pre-processing the decoded data by an improved endpoint detection algorithm to generate an effective sound segment of the original voice signal;
extracting feature information of the effective sound segment by a feature extraction algorithm; and
performing vector quantization on the feature information to generate the voice features.

3. The voice wake-up method according to claim 2, wherein the step of pre-processing the decoded data by the improved endpoint detection algorithm to generate the effective sound segment of the original voice signal comprises steps:
filtering an interference signal in the decoded data to generate filtered data;
performing pre-emphasis processing on the filtered data to generate pre-emphasis data;
framing the pre-emphasis data to generate frames of data;
windowing each of the frames of the data to generate windowing data;
extracting effective contents in the windowing data based on the improved endpoint detection algorithm; and
calculating the effective contents based on a Mel-frequency cepstrum coefficient feature extraction algorithm to generate the effective sound segment of the original voice signal.

4. The voice wake-up method according to claim 2, wherein the improved endpoint detection algorithm comprises a formula
$$δ = φ \times \frac{{δ}_{max} - {δ}_{min}}{{ρ}_{max} - {ρ}_{min}} \times ρ ;$$
ρ is a short-term energy change rate; δ is a short-term energy threshold; φ is an adjustable influence factor.

5. The voice wake-up method according to claim 1, wherein the step of performing pattern matching on the voice features according to the hidden Markov model to generate the recognition result comprises:
according to the hidden Markov model, performing pattern matching on the voice features by a forward algorithm; determining whether the original voice signal input by the user comprises a predetermined command through a predetermined discrimination rule to generate the recognition result.

6. The voice wake-up method according to claim 5, wherein the step of according to the hidden Markov model, performing pattern matching on the voice features by the forward algorithm and determining whether the original voice signal input by the user comprises the predetermined command through the predetermined discrimination rule to generate the recognition result comprises:
converting the voice features into symbol sequences by vector quantization, where the voice features are two-dimensional voice features and the symbol sequences are one-dimensional symbol sequences;
exhaustive all state sequences corresponding to a symbol sequence of a current frame of the data to generate feature frame sequences;
obtaining a generation probability of the feature frame sequences generated by each of the state sequences according to a transition probability and a transmission probability;
extending a quantity of states in each of the state sequences to a quantity of feature frames, summing probabilities of generating the feature frame sequences of the state sequences, and using a sum thereof as a likelihood probability that the feature frame sequences are identified as word sequences;
calculating probabilities of the word sequences of the feature frame sequences in the hidden Markov model as prior probabilities of the word sequences;
multiplying the likelihood probability and each of the prior probabilities to obtain posterior probabilities of the word sequences; and
using one of the word sequences having a maximum posterior probability as the recognition result.

7. An electronic device, comprising: an external processor and a smart microphone;
wherein the smart microphone comprises a microphone and a digital signal processor; the microphone is configured to collect an original voice signal input by a user;
the digital signal processor is configured to generate pulse density modulation data according to the original voice signal, decode the pulse density modulation data to generate decoded data; perform preprocessing and feature extraction processing on the decoded data to generate voice features, perform pattern matching on the voice features according to a hidden Markov model to generate a recognition result, and send the recognition result to the external processor;
the external processor is woke up according to the recognition result.

8. The electronic device according to claim 7, wherein the digital signal processor is further configured to receive the hidden Markov model sent by a server, and the hidden Markov model is trained by the server.

9. The electronic device according to claim 7, wherein the external processor comprises a central processing unit (CPU) or a system-on-chip.

10. A computer-readable storage medium, comprising: a program stored therein; wherein when the program is operated, a device where the computer-readable storage medium is disposed is controlled to execute the voice wake-up method according to claim 1.
